(19) United States
(12) Patent Application Publication
(10) Pub. No.: US 2010/0250407 A1
(43) Pub. Date: Sep. 30, 2010

(54) SYSTEMS, METHODS AND MACHINE-READABLE MEDIUMS FOR CONSOLIDATING FINANCIAL INFORMATION FROM MULTIPLE ACCOUNTS MAINTAINED WITH A PLURALITY OF FINANCIAL INSTITUTIONS

(76) Inventor: Edson Silva, Florianopolis (BR)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/500,205

(22) Filed: Jul. 9, 2009

Related U.S. Application Data
(60) Provisional application No. 61/164,854, filed on Mar. 30, 2009.

(51) Int. Cl. G06Q 40/00; G06Q 10/00; G06Q 30/00; G06F 15/16; G06Q 20/00

(52) U.S. Cl. 705/30; 705/34; 705/35; 705/37; 705/38; 709/206

(57) ABSTRACT

Systems, methods and machine-readable mediums for consolidating financial information from multiple accounts maintained with a plurality of financial institutions. The systems may include a storage device and a processor. The storage device may store commercial data from a plurality of businesses and financial data from a plurality of financial institutions. The financial data may include at least one business account information maintained with each financial institution. The processor may execute code instructions to consolidate the financial data and perform at least one of the following operations: (1) determine if at least one business has a projected negative cash flow; (2) transmit an electronic notification to a payee/beneficiary of a scheduled payment from at least one payor's bank account; and (3) transmit a loan application and report on the financial and commercial data of the at least one business to a lending institution terminal. The computer readable mediums provide instructions to cause the processor to perform the operations above.

### RELATED APPLICATION

This application claims the benefit of and priority to U.S. Provisional Application Ser. No. 61/164,854, filed Mar. 30, 2009, by Edson Silva, entitled SYSTEM, METHOD AND MACHINE-READABLE MEDIUM FOR PROVIDING VISIBILITY OF TRANSACTIONS IN A COMMERCIAL ECOSYSTEM, the contents of which are incorporated by reference herein in its entirety.

This application is also related to the following co-pending U.S. patent applications, filed concurrently herewith, by Edson Silva, and which are incorporated herein by reference in their entirety: (a) U.S. patent application Ser. No. ______ (Attorney docket No. 116454.200200), entitled SYSTEMS, METHODS AND MACHINE-READABLE MEDIUMS FOR MANAGING COMMITMENTS AND ACCOUNT RECEIVABLES; (ii) U.S. patent application Ser. No. ______ (Attorney docket No. 116454.200300), entitled SYSTEMS, METHODS AND MACHINE-READABLE MEDIUMS FOR SUBMITTING ELECTRONIC LOAN APPLICATIONS TO A LENDING INSTITUTION WITH REAL-TIME COMMERCIAL AND FINANCIAL DATA; and (iii) U.S. patent application Ser. No. ______ (Attorney docket No. 116454.200100), entitled SYSTEMS, METHODS AND MACHINE-READABLE MEDIUMS FOR PROVIDING REAL-TIME DATA OF COMMERCIAL AND FINANCIAL ACTIVITY OF A BUSINESS TO A FINANCIAL INSTITUTION TO GUIDE CREDIT OPERATIONS AND RISK MANAGEMENT.

### BACKGROUND

This disclosure relates generally to systems, methods and machine-readable mediums for accessing financial data. More particularly, this disclosure relates to systems, methods and machine-readable mediums for consolidating financial information from multiple accounts maintained with a plurality of financial institutions, which can be used to manage a company's commitments and account receivables and guide a lending institution's credit operations and risk management.

### SUMMARY

Systems, methods and machine-readable mediums for consolidating financial information from multiple accounts maintained with a plurality of financial institutions. The systems may include a storage device and a processor. The storage device may store a customer's financial data from a plurality of financial institutions. The financial data may include at least one business account information maintained with each financial institution. The storage device may also store commercial data from a plurality of businesses.

In one embodiment, the processor may be programmed with code instructions to receive the commercial data from a plurality of business terminals and receive the financial data from a plurality of financial institution terminals. The processor may then store the commercial data and the financial data in the storage device. Next, the processor may consolidate the financial data from each financial institution. In one embodiment, the processor may then determine if one or more customer companies has a projected negative cash flow based on the received commercial and/or financial data received, generate a report to identify at least one business that has a projected negative cash flow, and transmit the report to at least one financial institution terminal to facilitate a financial institution's credit operations and risk management.

In another embodiment, the consolidated financial information may be used with a system, method and machine-readable medium for electronically notifying beneficiaries of a scheduled payment. The system may include a storage device and a processor. The storage device may store data including at least one payee contact information and a payor's bank account information for a plurality of financial institutions. The payor's bank account information may include a payor's bank name, a payor's bank contact information, a payor's bank account number, and a payor's bank routing number. The processor may be programmed with code instructions to receive the data from a payor terminal and transmit the data to the storage device for storage. The processor may then receive an electronic authorization from the payor terminal to schedule a payment, from at least one payor's bank account information, to a payee. The processor may retrieve the payee's contact information from the storage device to transmit a first electronic notification to the payee of the payment scheduled to be made at the certain date. The processor may then transmit the first electronic notification to the payee of the payment scheduled to be made at the certain date. The processor may also transmit a second electronic notification to the payor's bank contact information to debit the scheduled payment from the payor's bank account for remittance of an invoice.

In yet another embodiment, the consolidated financial information may also be used with a system, method and machine-readable medium for processing loan applications. The system may include a storage device and a processor. The storage device may store commercial data and financial data for a plurality of businesses. The storage device may also store selection criteria data for a plurality of lending institutions. The financial data may be obtained from a plurality of financial institutions and may include at least one business account information maintained with each financial institution. The processor may be programmed with code instructions to receive a loan application from at least one business. The processor may then retrieve, from the storage device, the commercial data and the financial data for the at least one business. The processor may generate a report on a financial condition of the at least one business based on the financial data and the commercial data. As can be appreciated, the processor may be programmed with code instructions to apply the selection criteria data to filter the at least one business based on its financial condition and to automatically select one or more lending institutions from the plurality of lending institutions. The processor may then transmit the report and the loan application to a lending institution terminal for each of the selected lending institutions.

The methods include the operations above performed by the processor. The computer readable mediums provide instructions to cause the processor to perform the operations above. As such, the methods, systems and machine-readable mediums embodied in the present disclosure facilitate electronic management of commitments and account receivables between companies.

### DRAWINGS

The above-mentioned features and objects of the present disclosure will become more apparent with reference to the following description taken in conjunction with the accompanying drawings wherein like reference numerals denote like elements and in which:

FIG. 1 illustrates an exemplary block diagram of a system for providing real-time commercial and financial data, according to one embodiment of the present disclosure.

FIG. 2 illustrates an exchange of commercial and financial data through the visibility system of FIG. 1, according to an embodiment of the present disclosure.

FIG. 3 illustrates an exemplary flowchart outlining the operation of the visibility system of FIG. 1, according to an embodiment of the present disclosure.

FIG. 4 illustrates an exemplary flowchart outlining the operation of the visibility system of FIG. 1 for identifying, to a financial institution, potential companies qualified to receive credit, according to an embodiment of the present disclosure.

FIG. 5 is an exemplary flow diagram illustrating document conversion, reconciliation and reporting by the visibility system of FIG. 1, according to an embodiment of the present disclosure.

FIG. 6 illustrates an exemplary flowchart outlining the operation of the visibility system of FIG. 1 for electronically notifying beneficiaries of a scheduled payment, according to an embodiment of the present disclosure.

FIG. 7 illustrates an exemplary flowchart outlining the operation of the visibility system of FIG. 1 for electronically managing commitments and receivables between companies, according to an embodiment of the present disclosure.

FIG. 8 illustrates an exemplary flowchart outlining the operation of the visibility system of FIG. 1 for registering at least one financial institution to process client commitments and remit invoices, according to an embodiment of the present disclosure.

FIG. 9 is an exemplary flow diagram illustrating electronic submission of loan applications to a financial institution using the visibility system of FIG. 1, according to an embodiment of the present disclosure.

FIG. 10 illustrates an exemplary flowchart outlining the operation of the visibility system of FIG. 1 for submitting electronic loan applications to one or more financial institutions with real-time commercial and financial data of a business, according to an embodiment of the present disclosure.

FIG. 11 illustrates an exemplary flowchart outlining the operation of the visibility system of FIG. 1 for matching a borrower to one or more lending institutions, according to an embodiment of the present disclosure.

FIG. 12 illustrates an exemplary flowchart outlining the operation of the financial institution terminal of FIG. 1 for extending a credit or a loan, according to an embodiment of the present disclosure.

FIG. 13 is an exemplary table illustrating consolidation of financial information from a plurality of financial institutions, according to an embodiment of the present disclosure.

FIG. 14 is an exemplary table illustrating consolidation of financial information from multiple accounts maintained with Bank A of FIG. 13, according to an embodiment of the present disclosure.

FIG. 15 is an exemplary table illustrating financial transactions occurring within a predetermined period from multiple accounts maintained with Bank B of FIG. 13, according to an embodiment of the present disclosure.

FIG. 16 is an exemplary search engine interface for filtering and/or consolidating the financial information, according to an embodiment of the present disclosure.

FIG. 17 illustrates an exemplary flowchart outlining the operation of the visibility system of FIG. 1 for consolidating financial information from multiple accounts maintained with a plurality of financial institutions, according to an embodiment of the present disclosure.

FIG. 18 illustrates an exemplary flowchart outlining the operation of the visibility system of FIG. 1 for utilizing consolidated financial information to identify potential companies qualified to receive credit, according to an embodiment of the present disclosure.

FIG. 19 illustrates an exemplary flowchart outlining the operation of the visibility system of FIG. 1 for electronically notifying beneficiaries of a scheduled payment from at least one payor's bank account, according to an embodiment of the present disclosure.

FIG. 20 illustrates an exemplary flowchart outlining the operation of the visibility system of FIG. 1 for submitting electronic loan applications to one or more financial institutions with real-time commercial data and real-time financial data of a business, according to an embodiment of the present disclosure.

### DETAILED DESCRIPTION

In the description that follows, the present inventions will be described in reference to one or more embodiments that facilitate consolidation and/or filtering through financial information from multiple accounts maintained with a plurality of financial institutions. The present inventions, however, are not limited to any particular application nor is it limited by the examples described below. Various modifications to the disclosed embodiments will be apparent to those skilled in the art and the general principles defined herein may be applied to other embodiments and applications without departing from the spirit and scope of the inventions. Therefore, the description of the embodiments that follow are for purposes of illustration and not limitation.

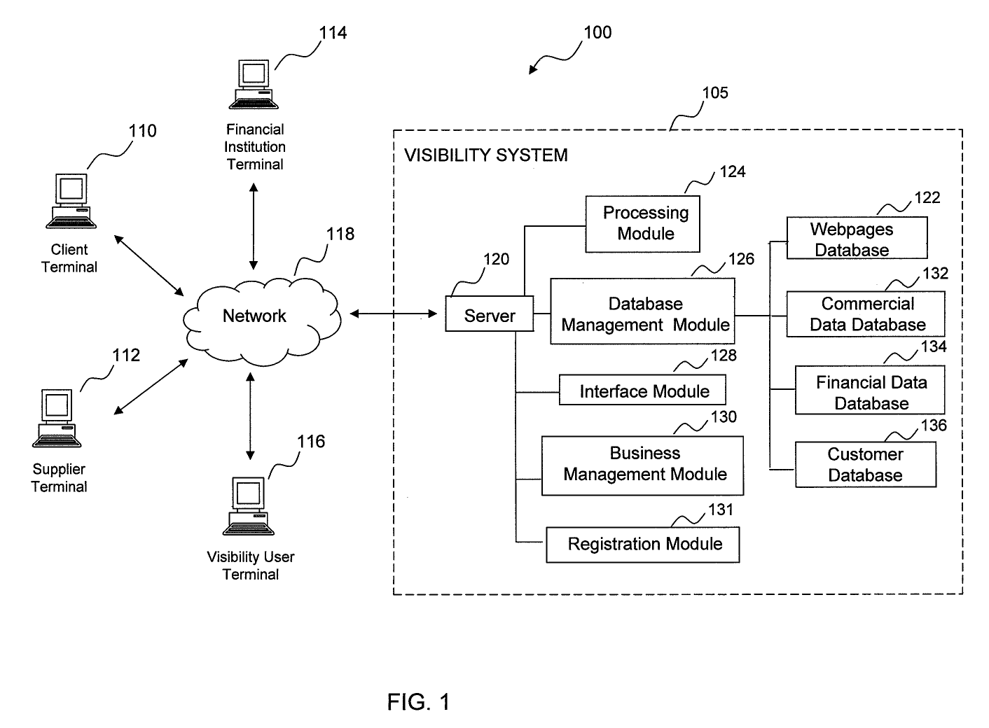

FIG. 1 illustrates an exemplary block diagram of a system 100 for providing real-time commercial and financial data, according to one embodiment of the present disclosure. The real-time commercial and financial data of a business may be provided to a financial institution for visibility to guide credit operations and risk management. As used herein, “real-time” may refer to a mode of computer operation by which a computer updates data at substantially the same rate as the data is being received by the computer. “Real-time data” may include substantially up-to date information available on a computer system.

As shown in FIG. 1, a visibility system 105 may be accessible to a client terminal 110, a supplier terminal 112, a financial institution terminal 114 and a visibility user terminal 116, such as personal computers, phones and personal digital assistants, via a network 118. The terminals 110, 112, 114, 116 may run commercially-available Web browser applications such as Microsoft Internet Explorer®, which implements World Wide Web standards such as HTTP, HTML, XML, java, Flex, Ajax and the like.

In one embodiment, the visibility system 105 may include a server 120, one or more modules and one or more storage devices. The website content may be distributed over several Internet domains, and may be implemented using several servers located at various locations. Of course, a variety of networks, both public and private, may be used as well. The visibility system 105 may use a commercially-available Internet server 120 which accesses a web page database 122 that may be used to store and/or dynamically generate Web pages in response to end user actions. The Web pages may be in the form of HTML pages or the like.

The server 120 may include one or more processors for implementing one or more functional modules, such as a processing module 124, a database management module 126, an interface module 128, and a business management module 130. As used herein, the term module refers to logic implemented in hardware and/or software. It may include a collection of software instructions, possibly having entry and exit points, written in a programming language, such as, for example, C++. A software module may be compiled and linked into an executable program, or installed in a dynamic link library, or may be written in an interpretive language such as BASIC. It will be appreciated that software modules may be callable from other modules, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays. The modules described herein are preferably implemented as software modules, but could be represented in hardware or firmware.

In one embodiment, each module is provided as a modular code object, where the code objects typically interact through a set of standardized function calls. In one embodiment, the code objects are written in a suitable software language such as C++, but the code objects can be written in any low level or high level language. In one embodiment, the code modules are implemented in C++ and compiled on a computer running a content server, such as, for example, Microsoft® IIS or Linux® Apache. Alternatively, the code modules can be compiled with their own front end on a kiosk, or can be compiled on a cluster of server machines and transmitted through a cable, packet, telephone, satellite, or other telecommunications network. Artisans of skill in the art will recognize that any number of implementations, including code implementations directly to hardware, are also possible.

The database management module 126 may be used to provide database management functions for interrelated storage devices, including, for example, a web pages database 122, a commercial data database 132, a financial data database 134, and a customer database 136. As is well known, database categories above can be combined, further divided or cross-correlated, and any combination of databases 122, 132, 134, 136 and the like can be provided from within the server 120. In one embodiment, any portion of the databases can be provided externally from the visibility system 105, either locally on the server 120, or remotely over a network. The external data from an external database can be provided in any standardized form which the server 120 can understand. For example, an external database at a provider can advantageously provide end-user data in response to requests from server 120 in a standard format, such as, for example, name, user identification, and computer identification number, and the like, and the end-user data blocks are transformed by the database management module 126 into a function call format which the code modules can understand. The database management module 126 may be a standard SQL server, where dynamic requests from the server 120 build forms from the various databases used by the visibility system 105 as well as store and retrieve related data on the various databases.

As can be appreciated, the databases may be used to store, arrange and retrieve data. The databases may be storage devices such as machine-readable mediums, which may be any mechanism that provides (i.e. stores and/or transmits) information in a form readable by a processor. For example, the machine-readable medium may be a read only memory (ROM), a random access memory (RAM), a cache, a hard disk drive, a floppy disk drive, a magnetic disk storage media, an optical storage media, a flash memory device or any other device capable of storing information. Additionally, machine-readable medium may also comprise computer storage media and communication media. Machine-readable medium includes volatile and non-volatile, removable and non-removable media implemented in any method or technology for storage of information such as computer-readable instructions, data structures, program modules or other data. Machine-readable medium also includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by a computer.

In one embodiment, the commercial data database 132 may be used to store commercial records for at least one client and/or supplier business. For example, the commercial data database 132 may store any electronic data associated with a commercial transaction, such as, but not limited to, purchase orders, receipts, invoices, titles, contracts, etc. The financial data database 134 may be used to store financial records for at least one client and/or supplier business. For example, the financial data database 134 may store payments, collections, bank and credit card statements, etc.

The customer database 136 may be used to store data associated with a customer account for a user to access the visibility system 105. For example, the customer database 136 may be used to store sign up information associated with the customer account. The customer may be a client accessing the client terminal 110, a client's supplier accessing the supplier terminal 112, a financial institution accessing the financial institution terminal 114, or any other user with preauthorized rights to access the client's records and accessing the visibility user terminal 116.

The processing module 124 may be responsive to the receipt of customer log-in information from the client terminal 110, the supplier terminal 112, the financial institution terminal 114 and/or the visibility user terminal 116. The processing module 124 may be used to retrieve a customer profile data from customer database 136 in response to the customer log-in information. The processing module 124 may be operatively associated with a number of different modules. For example, the processing module 124 may be operatively associated with the business management module 130 to process commercial and financial data transmitted to and from the visibility system 105. In one embodiment, the processing module 124 may be used to receive commercial and/or financial data from at least one client terminal 110, and transmit the commercial and/or financial data to a database for storage. For example, the commercial data may be transmitted to the commercial data database 132 and the financial data may be transmitted to the financial data database 134 for storage. In one embodiment, the processing module 124 may be used to consolidate the commercial and financial data, and provide a credit report for each of the at least one client business. The processing module 124 may also be used to transmit the report to at least one visibility user terminal 116, such as a financial institution terminal with preauthorized access rights, to facilitate the financial institution's credit operations and risk management.

The interface module 128 may be operatively associated with a number of different modules. For example, the interface module 128 may be operatively associated with the registration module 131 to register users to the visibility system 105. The interface module 128 may be implemented to receive an identifier, such as an account username and password, for logging onto the visibility system 105 and for accessing associated customer account. By logging onto the visibility system 105, customers may securely access published information from partners, clients or suppliers, contract service, request anticipation of receivables, offer credit, emit second copy of billets, access invoices published by its partners, track scheduled payments, make reductions in financial documents based in the receivables, track orders/requests, digitize receipts, among other services.

In one embodiment, the interface module 128 may be used to send and receive documents in diverse formats and protocols, and convert messages/documents in one or more pre-determined formats for each customer (client/supplier/financial institution). The documents may be transmitted to the visibility system 105 from the customer, or transmitted to the customer from databases 122, 132, 134 of the visibility system 105.

The registration module 131 may be used to facilitate registration with the visibility system 105. The registration module 131 may be responsive to a customer's request to register on the visibility system 105. The registration module 131 may be responsive to customer information received in response to the prompting of customer information for storage in customer database 136. The customer information may be used to set up a customer account with the visibility system 105.

The business management module 130 may be used to provide business management functions for commercial and financial transactions. For example, the business management module 130 may be used to consolidate financial and commercial information for providing new and strategic data to approve credit lines and limit credit risks. The business management module 130 may be used to convert and/or integrate all documents from commercial transactions and extract the financial information therefrom. For example, orders generated at the client terminal 110 may be converted into future payments, and orders received at the client terminal 110 may be converted into receivables. Additionally, invoices received at the client terminal 110 may be combined with the orders and future payments, redefining the details of these payments. Similarly, invoices generated at the client terminal 110 may be combined with the receivables, redefining details of these receivables. All other documents may be integrated as well, allowing the client and/or visibility user, through their respective terminals 110, 116, to access and view all the selling and buying process from a financial viewpoint.

In one embodiment, the business management module 130 may be used to facilitate financial transactions between, for example, a client terminal 110 and a supplier terminal 112. For example, the business management module 130 may be used to schedule and transmit payment conciliation to the financial institution terminal 114. As can be appreciated, the business management module 130 may be used to provide a history log of all documents exchanged between a client and each of its business partners, suppliers, etc., and the related cash flow. In one embodiment, the business management module 130 provides such information to the client terminal 110 upon log-in to the visibility server 105. In another embodiment, the business management module 130 provides such information to any visibility user terminal 116, such as a terminal at a financial institution, with preauthorized access rights from the client business. By having access to the client business' documents (future payments and receivables), the financial institution has visibility to the business' commercial and financial condition, and as such, can provide credit with a lower risk.

In one embodiment, the business management module 130 may be a set of integrated systems providing one or more functional applications to support the automation, standardization, publication, control and management of integrated public and private companies in their value chain. For example, the business management module 130 may be used to integrate customers, such as, but not limited to, clients, suppliers, banks, credit card companies, transport companies, insurance companies, governments and others business partners. The business management module 130 may be configured for multiple interfaces, for financial, logistic, and mercantile portals, for registration and electronic contracting, and for multiple individual configurations of available portals. In one embodiment, the business management module 130 may be used to automate and modernize the traditional process of orders, receipts, payments, collections, bank statements, scan of client, electronic contracts, including other logistic, mercantile and financial procedures, rules and forms.

As can be appreciated, the business management module 130 may be configured to provide different functionalities and access rights for different customers. For example, the business management module 130 may provide different information related to the profile of each customer (client, supplier and/or financial institution) accessing the visibility system 105. In one embodiment, the business management module 130 may be used to facilitate the connectivity and transport of data in a secure environment. The business management module 130 may be used for mapping and translation of electronic document layouts, and optionally supplying standard layouts to customers. For example, it permits each customer to utilize a certain electronic document layout or adopts an industry standard layout, making the electronic exchange of information among customers (clients/suppliers/financial institutions) feasible. Hence, the business management module 130 may facilitate remitting and/or receiving information, such as mercantile-logistics and/or financial information, without the need of altering the format of any existing document.

In one embodiment, the business management module 130 may be used to integrate business partners (clients, suppliers, transport companies, insurance companies, etc) by facilitating the electronic exchange of orders to suppliers, receipts/invoices to clients, knowledge of boarding, confirmation of receipts, including other logistic and/or mercantile documents. The business management module 130 may also be used to integrate client terminal 110 or supplier terminal 112 with financial institution terminal 114 for electronic exchange of financial information, for example, payments, collections, bank and credit card statements, electronic scan of billets, purchases, sells, among others financial documents. The business management module 130 may be used to electronically manage collections for a supplier company and its clients to enable, for example, the remittance of billets by email, publication on the client's profile webpage, or remittance of electronic files to clients. Furthermore, it may be used to notify the supplier terminal 112 when a client terminal 110 accesses the visibility system 105 for tracking billets from remittance to payment.

As can be appreciated, the business management module 130 may facilitate electronic scans to track collections registered with the financial institution terminal 114 and/or the visibility system 105. Additionally, the business management module 130 may be used to manage payments from clients to suppliers, for example, by authorizing payments to suppliers, payment of tributes with or without bar code, authorizing payroll, and publication of payments and commitments recognized for the suppliers. Payments are identified as payables to the client and receivables to the supplier. The business management module 130 may be operatively associated with the database management module 126 to transmit financial information, such as payables and receivables, to the financial data database 134 for storage.

In one embodiment, the business management module 130 may be used to generate financial documents in connection with commitments and receivables. For example, the business management module 130 may allow a supplier at a supplier terminal 112 to generate financial documents (collection, payments) from documents of commitments published (receipt, invoices and titles). Furthermore, the business management module 130 may be used to manage the assembly of commitments, the anticipation or payment by installments of commitments, and the generation of a new billet with reduced value based on previous billets and receivables. When the client company renders a payment, the business management module 130 may be used to reconcile the commitments with the payments scheduled/rendered. The business management module 130 may also be used to manage the anticipation of receivables. The business management module 130 may be used to post commitments recognized by the client company to the supplier, and may request the anticipation of receivables based on such information.

In one embodiment, the business management module 130 may also be used to capture, consolidate and publish on one or more web pages, any bank statements from a plurality of bank accounts maintained at a plurality of financial institutions.

As is understood by a person skilled in the art, the code modules may be compiled on one or more servers 120, each having one or more processors, to perform a set of functional calls. In one embodiment, the one or more processors may be configured, programmed and/or provided code instructions from one or more modules to receive commercial and/or financial data from at least one client business terminal, and transmit the commercial and/or financial data to a database for storage. For example, the commercial data may be transmitted to the commercial data database 132 and the financial data may be transmitted to the financial data database 134 for storage. In one embodiment, the processor may be configured, programmed and/or provided code instructions from one or more modules to consolidate the commercial and financial data to provide a credit report for each of the at least one client business. The processor may also be configured, programmed and/or provided code instructions from one or more modules to transmit the report to at least one visibility user terminal 116, such as financial institution terminal with preauthorized access rights, to facilitate the financial institution's credit operations and risk management.

The visibility to financial institutions and companies may be achieved by the presentation of the information in a web-based software or any other kind of online service. This allows financial institutions to consider suppliers and clients in the credit analysis process. As can be appreciated, the visibility system 105 provides added value to financial institutions (to make credit offers to potential clients) and to companies (providing more commercial and financial information to a financial institution for reviewing and assessing the companies' credit worthiness and associated risk).

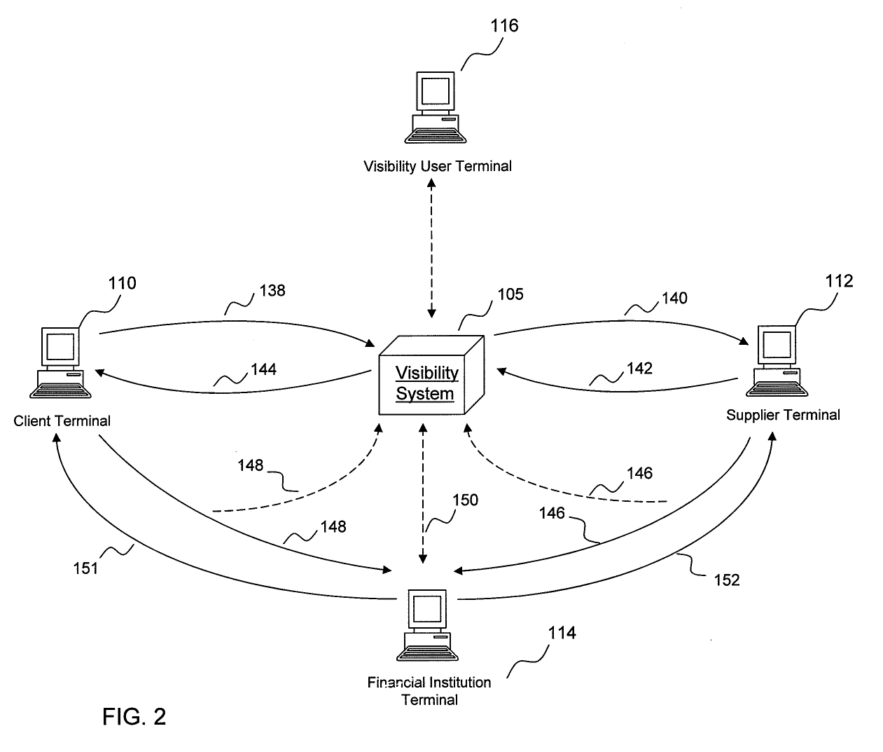

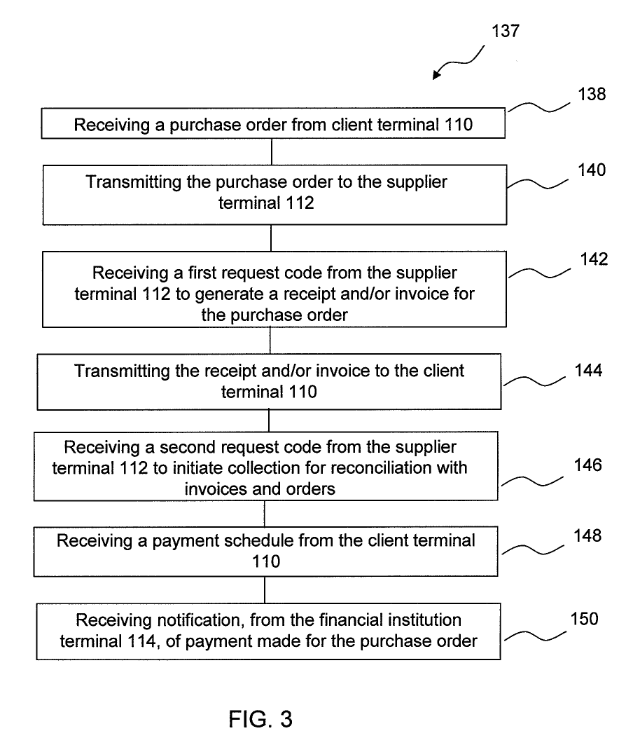

FIG. 2 illustrates an exchange of commercial and financial data through the visibility system 105 of FIG. 1, according to an embodiment of the present disclosure. FIG. 3 illustrates an exemplary flowchart 137 outlining the operation of the visibility system 105 of FIG. 1, according to an embodiment of the present disclosure. As can be appreciated, the server 120 of the visibility system 105 may be programmed with code instructions to facilitate the exchange of commercial and financial data between companies. As can be appreciated, the server 120 of the visibility system 105 may be programmed with code instructions to facilitate the exchange of commercial and financial data between companies. The visibility system 105 may be programmed, for example, by transmitting code instructions to the server 120 from a local or remote storage device. The server 120 may be programmed with instructions to receive a purchase order from the client terminal 110 (138). The server 120 may store the purchase order information, in the commercial data database 132, as an account payable to the client and account receivable to the supplier. In one embodiment, the stored purchase order information may then be itemized as income/expense and may be accessible for display on the client terminal 110, the supplier terminal 112 and/or the financial institution terminal 114. The stored purchase order information may also be accessible for display to any visibility user 106 with preauthorized rights from the client or supplier.

After receiving the purchase order, the server 120 may transmit the purchase order to the supplier terminal 112 (140). The supplier may then transmit, to the server 120, a first request code to generate a receipt and/or invoice for the purchase order (142). The server 120 may then generate a receipt/invoice and transmit the same to the client terminal 110 (144). In one embodiment, the server 120 may reconcile the information on the receipt with the purchase order. The server 120 may update the account payable to the client and account receivable to the supplier based on the reconciled information. Since the purchase order may be considered a commitment of payment, reconciling the invoice with the supplier's account receivables provides greater level of confidence in the supplier's revenue stream. However, since there is a minor probability that the client cancels the purchase order after the supplier has generated an invoice, the purchase order may be considered a commitment with a greater confidence. This commitment provides visibility, inside the supplier's operations, for a financial institution to guide its credit operations and risk management.

As can be appreciated, the supplier may use the invoice for anticipation of receivables to request a line of credit, from the financial institution, to meet its obligations under the purchase order. Alternatively, the supplier may transmit, to the server 120, a second request code to initiate payment collection, from the financial institution, for reconciliation with the invoice and purchase order, thereby further increasing the confidence level in the records of payables and receivables (146). The client may then transmit a request code to the server 120 to schedule a payment of the invoice with the financial institution (148). The server 120 may store the information as “payables scheduled”, affirming the commitment to the date scheduled. Once the payment is made on the scheduled date, the financial institution terminal 114 may transmit a notification to the client and the supplier, via the server 120 (150). The liquidation of payment closes the cycle of the invoice/receipt/order, and may be identified as “liquidated” on the server 120.

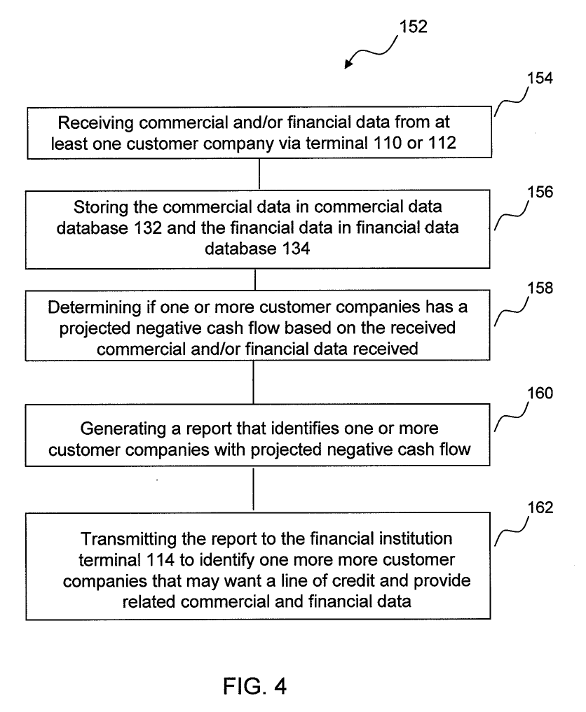

FIG. 4 illustrates an exemplary flowchart 152 outlining the operation of the visibility system 105 of FIG. 1 for identifying, to a financial institution, potential companies qualified to receive credit, according to an embodiment of the present disclosure. Financial institutions generally have certain criteria for extending credit based on their credit operational guidelines and risk management. As can be appreciated, this criteria may be provided to the visibility system 105, via the financial institution terminal 114. Based upon a company's commercial and/or financial activity, the visibility system 105 may determine whether the company satisfies the financial institution's criteria for receiving credit. The visibility system 105 may then identify the pre-qualified company to the financial institution for extending credit. In one embodiment, the visibility system 105 identifies one or more pre-qualified companies to the financial institution periodically, for example, hourly, daily, monthly, quarterly, etc.

The visibility system 105 may generate a Cash Need Report that provides information on one or more companies that have a projected negative cash flow. The Cash Need Report may be used by the financial institution to identify potential clients for credit operations. In one embodiment, the Cash Need Report may be provided to the financial institution in response to an online search criteria transmitted from the financial institution terminal 114 to the visibility system 105. Alternatively, the Cash Need Report may be automatically generated on all participating companies (companies that authorized inclusion on the report) to allow the financial institution to review and identify potential clients for credit operations.

In one embodiment, the visibility system 105 may also generate a Cash Flow Report to provide all financial transactions of a company within a certain period. Based on the company's cash flow information, the financial institution may be able to determine whether the company will be able to pay monthly for a loan or default on the loan. The Cash Flow Report may be provided to the financial institution in response to an online search criteria transmitted from the financial institution terminal 114 to the visibility system 105. Alternatively, the visibility system 105 may also automatically generate the Cash Flow Report on all participating companies to allow the financial institution to review and identify potential clients with sufficient cash flow for extending a line of credit.

As can be appreciated, the server 120 of the visibility system 105 may be programmed with code instructions for identifying, to a financial institution, potential companies qualified to receive credit. The visibility system 105 may be programmed, for example, by transmitting code instructions to the server 120 from a local or remote storage device. Referring to FIG. 4, the server 120 may be programmed with instructions to receive commercial data from at least one customer company via terminals 110 or 112 and/or financial data for each customer company from at least one terminal 114 (154). The commercial data may be stored in commercial data database 132 and the financial data may be stored in financial data database 134 (156). Next, the server 120 may be programmed to determine if one or more customer company has a projected negative cash flow based on the received commercial and/or financial data received (158). The server 120 may generate a report, such as a Cash Need Report, to identify the one or more customer company with projected negative cash flow (160). The server 120 may then transmit the report to the financial institution terminal 114 to identify one or more customer company that may want a line of credit (162). The server 120 may also generate a Cash Flow Report, to provide all financial transactions on one or more customer company within a certain period. As noted above, the reports may be provided to the financial institution in response to an online search criteria transmitted from the financial institution terminal 114 to the visibility system 105. Alternatively, the reports may be automatically generated on all participating customer companies (companies that authorized inclusion on the report) to allow the financial institution to review and identify potential clients that may want or need a line of credit.

As can be appreciated, a customer company may authorize the financial institution to access the company's commercial and financial records. With authorized access to the company's commercial and financial records, the financial institution can better assess the risk associated with extending a credit line to the company. In one embodiment, the financial institution may receive real-time data of the customer company's commercial and financial activity. As such, the financial institution can, for example, determine whether the company, with negative cash flow, has accounts receivables from purchase orders that will cover for the line of credit. Similarly, the financial institution can also determine if a company can make a certain monthly payment on a loan based on the company's cash flow records. If so, the financial institution can extend the line of credit with higher confidence and reduced risk that the company would default on the loan.

By storing commercial and financial records, the visibility system 105 may be configured to analyze the activity of a company, its clients, suppliers and financial agents, and provide statistical data in real time, with greater precision, regarding new service and credit offerings. This statistical data may be used to provide instantaneous business intelligence, helping the decision making and business response time to changes in the market. The real-time map of companies and their value-chain may allow the offering of immediate credit service using transactions and real-time confirmation of the involved companies as collateral to this operation.

Generally, prior art credit operations are based on historic behavior data and associated rating. However, this data is not enough to define the amount of transactions being done by a company or it's financial and productive capacity, or to understand the value-chain companies involved, which company participating in which value-chain, and the financial and mercantile capacities of the value-chain. Credit operations using paper transactions as collateral, without real time mercantile transactions, cannot assure that the company will be able to pay for the loan. As such, prior art credit operations are high risk transactions. Any oscillation in the market can affect many companies, and the systemic risk is not taken into consideration.

Using the visibility system 105 to provide real-time mercantile operations as collateral, and having one or more databases to converge this information, companies may now be better positioned to prove their payment capacity. Furthermore, the systemic risk (the risk of the whole value-chain) can be analyzed in real time. As such, the credit limit that a financial institution can concede to each company can be safely established based on confirmed receivables each company has. This allows the financial institution to offer credit with lower interest rate, and companies receiving this credit with lower interest rate are likely to become more competitive in the marketplace.

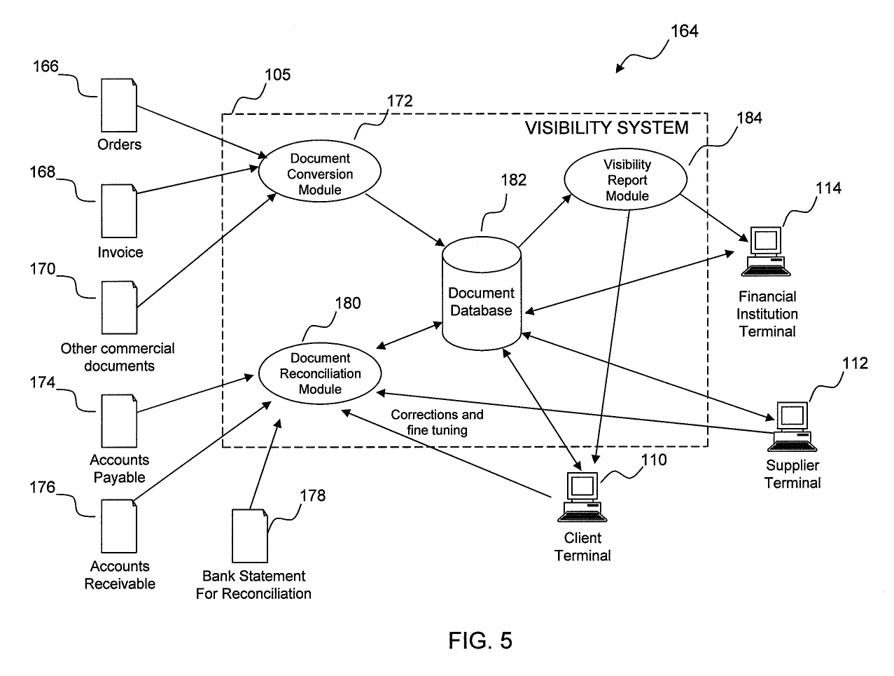

As noted above, the visibility system 105 may be used to automate and modernize the traditional process of orders, receipts, payments, collections, bank statements, scan of client, electronic contracts, including other logistic, mercantile and financial procedures, rules and forms. FIG. 5 is an exemplary flow diagram illustrating document conversion, reconciliation and reporting by the visibility system 105 of FIG. 1, according to an embodiment of the present disclosure. The visibility system 105 may include a storage device, such as database 182, a document conversion module 172, a document reconciliation module 180 and a visibility report module 182. The document conversion module 172, the document reconciliation module 180 and the visibility report module 182 may be implemented by one or more processors of the server 120. As is well known, database categories can be combined, further divided or cross-correlated, and any combination of databases 122, 132, 134, 136 and the like may be combined as database 182. Similarly, functional modules may be combined, further divided or cross-correlated. For example, functional modules, such as document conversion module 172, document reconciliation module 180 and visibility report module 182 may be combined with or as business management module 130.

The document conversion module 172 may be used to convert all commercial documents, such as orders 166, invoices 168, and other commercial documents 170, into financial data (receivables and payables) based on the data contained in the commercial documents. This financial data, extracted from the commercial data, may then be stored in database 182. The extracted data may include the amount of money involved in each transaction and the due dates. Any order a company receives or invoice it generates is converted in a receivable amount, and each document is conciliated with ones already registered.

In one embodiment, the commercial data may be converted by integrating any Electronic Data Interchange (EDI) formatted documents (invoices, orders, payments) generated by the companies with Enterprise Resource Planning (“ERP”) systems. This integration may be made possible through transformation maps linking the data in the backend ERP with the EDI format. The interface module 128 may utilize the transformation maps to process the data received from each company using the visibility system 105.

In another embodiment, financial data may be extracted from commercial data that is not in any EDI format in at least two ways. First, the user can manually input the information on the user terminal. Second, the information may be imported from reports generated by company's ERP/Management system. As can be appreciated, the interface module 128 may also be configured to extract information from any plain text format (XML, HTML, EDI, JASON, . . . ), and have a “plugin” architecture adaptable with any company's proprietary formats.

During the conversion, each document that have any kind of reference to a document already in database 182 may be conciliated with this document, thereby maintaining coherency among the commercial documents in the visibility system 105. The visibility system 105 may be configured to identify documents that are related and have originated from a single commercial transaction. As such, if an invoice is generated after an order is fulfilled, the visibility system 105 does not count the amounts twice (even if originated from two separate documents).

The document reconciliation module 180 may be used to reconcile financial data, such as account payables 174, account receivables 176, and bank statements 178, with documents that are already on the database 182. The financial data may be reconciled by the following exemplary fields: date, value, entities involved and/or document numbers. As can be appreciated, the visibility system 105 may be configured to allow the supplier to set or prioritize the fields for reconciling each financial document.

The visibility report module 184 may be used to generate one or more report, which may then be transmitted to the supplier terminal 112. The report may provide information on the financial condition of a business based on its financial and commercial data. Based on the authorizations registered with the visibility system 105, the one or more report may be transmitted also to the financial institution terminal 114. Reports may be generated automatically, using data mining techniques, to alert suppliers and financial institutions about certain company activity, for example, when a company receives a large order and may need money to finance the production. The visibility report module 184 may generate a Cash Flow Report and a Cash Need Report as discussed above. Additionally, the visibility report module 184 may generate a Segment Report and a Position Report. The Segment Report may be used to show global market statistics, which may be sent to any company business in a market segment. This report uses data from all companies utilizing the visibility system 105, without identifying which company this data belongs to. The Position Report may be used to show how a company business is positioned inside its market segment. This report uses data from all companies in the market segment, compares this data with the data from the company business, and transmits this report to the company business upon request.

As can be appreciated by a person skilled in the art, the business management module 130 may be used to manage collections between companies in a commercial ecosystem. With companies integrated in the commercial ecosystem through the visibility system 105, managing collections between the companies is simplified. The business management module 130 may be used to provide electronic management of collections for the supplier, and remittance of billets by email, webpage publication, or remittance of an electronic file to the supplier's client. The business management module 130 may also be used to track billets from their remittance to payment, and to calculate interest charges for late payment in accordance with the supplier's contract terms and conditions.

In one embodiment, the business management module 130 may provide a supplier web portal and a client web portal, each being adapted for one or more functional applications to facilitate commercial and financial transactions between the supplier and its client. The supplier web portal may include one or more web pages for tracking and managing collection of titles. The one or more web pages may display the status of titles tracked through the visibility system 105. For example, the web pages may provide the following status updates: confirmed, liquidated, abatement, in registry, protested, emitted, recalculated, generated to the Graphic store. The web pages may log the instant in which the billet is accessed by the supplier's client through an access linked to the billet remitted by email or to the client's web portal, performing the function of an electronic “Real-time—Notice of Receipt” for the supplier. Among other managerial information, the supplier web portal may be used to allow the supplier company to see the nominal value, due date, amount paid by its client and dates of payment.

The supplier web portal may also allow the supplier company to select a method by which a client can access a bill. For example, the supplier web portal may allow the client to access the bill using the client's web portal, by sending an email, or other electronic transmission means known to persons skilled in the art. An electronic message may be transmitted to the client terminal 110 to access the bill from the client's web portal. An email may be transmitted to the client terminal 110 enclosing the bill or with a URL link to the bill.

The business management module 130 may be used to automate electronic authorization of payments, for example, payroll or bills from suppliers, from one or more financial institutions for remittance. In one embodiment, the business management module 130 may be configured to post information of payments scheduled, by a client for a beneficiary supplier, on the supplier's web portal, enabling, optionally, the request of anticipation of receivables by the supplier, as discussed in greater detail below. The client company may define the number of electronic signatures needed to authorize payment. The client web portal may be configured to provide access for payment authorization to only those personnel authorized by the client company. The client web portal may allow the authorized personnel to register one or more beneficiary suppliers. The beneficiary suppliers can be registered, for example, by manually entering their information using the client web portal or automatically by loading a file or retrieving from an electronic bill. The beneficiary supplier may review the details of the posted information, including name and electronic signature of authorizing personnel, and follow the status of the scheduled payment for anticipation of receivables.

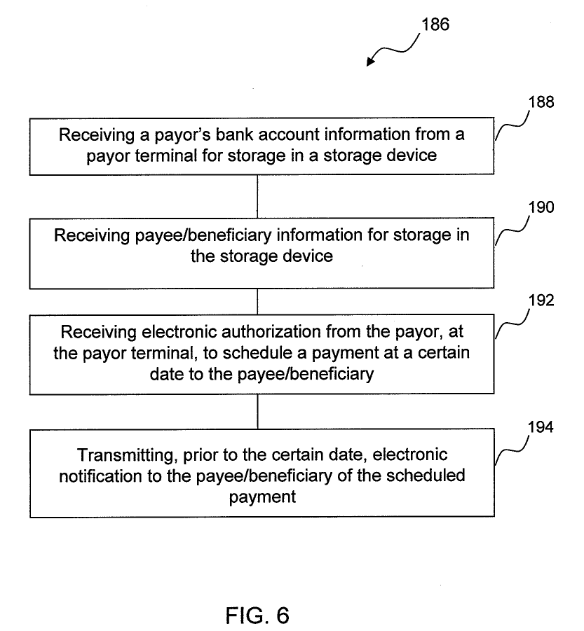

FIG. 6 illustrates an exemplary flowchart 186 outlining the operation of the visibility system 105 of FIG. 1 for electronically notifying beneficiaries of a scheduled payment, according to an embodiment of the present disclosure. As can be appreciated, the server 120 of the visibility system 105 may be programmed with code instructions to electronically notify beneficiaries of a scheduled payment. The server 120 may be programmed with instructions to receive, from a payor terminal, a payor's bank account information (188) and a payee/beneficiary information, for storage on a storage device (190). As used herein, the payor may be any individual or company paying another for a bill. For example, the payor may be a client paying a supplier (payee/beneficiary) for a bill. As such, the payor terminal may be a terminal operated by the client, such as client terminal 110. The payor may also be any individual or company paying payroll to one or more employees. For example, the payor may be a supplier paying payroll to one or more of its employees. As such, the payor terminal may be a terminal operated by the supplier, such as supplier terminal 112.

Next, the server 120 may receive electronic authorization from the payor, at the payor terminal, to schedule a payment to the payee/beneficiary (192). The payment may be scheduled at a later date for remittance from the payor's bank account. The server 120 may retrieve the payee's contact information (i.e. email) from the storage device. The server 120 may then transmit an electronic notification to the payee/beneficiary of the scheduled payment (194). The electronic notification may be in the form, for example, of an email alert or posted on the beneficiary's web portal. The information may include the time, date and amount of payment scheduled. As can be appreciated, the payee/beneficiary may review the details of the posted information and follow the status of the scheduled payment for anticipation of receivables. On the scheduled date, the payment may be withdrawn from the payor's bank account for remittance. If the payor/client has registered the bank with the visibility system 105, the server 120 may transmit an electronic notification to the bank terminal 114 for processing to debit the scheduled payment from the payor's bank account.

As noted above, the business management module 130 may be used to manage commitments and account receivables between companies in a commercial ecosystem, such as, managing commitments of clients (debtors) and receivables for suppliers (creditors). In one embodiment, the business management module 130 may be configured to manage commitments and receivables through a web portal. The web portal may be accessible to the client, supplier and/or financial institution via their respective terminals 110, 112, 114.

In one embodiment, the web portal for managing commitments and receivables may be used to post commitments recognized by a client company (payor) to a supplier (payee), request the anticipated receivables based on this information, and generate electronic bills from related electronic commercial documents. The supplier (payee) may use the web portal to display, at the supplier terminal 112, the commitments published (receipt) and recognized by the client (payor), or of payments scheduled by the client (payor) from the payor's bank account. Using the web portal, the supplier (payee) may generate documents, such as bills, for a commitment/scheduled payment recognized by the client (payor) to the supplier (payee). The payor or payor's financial institution may access these documents through the web portal on their respective terminals 110, 114.

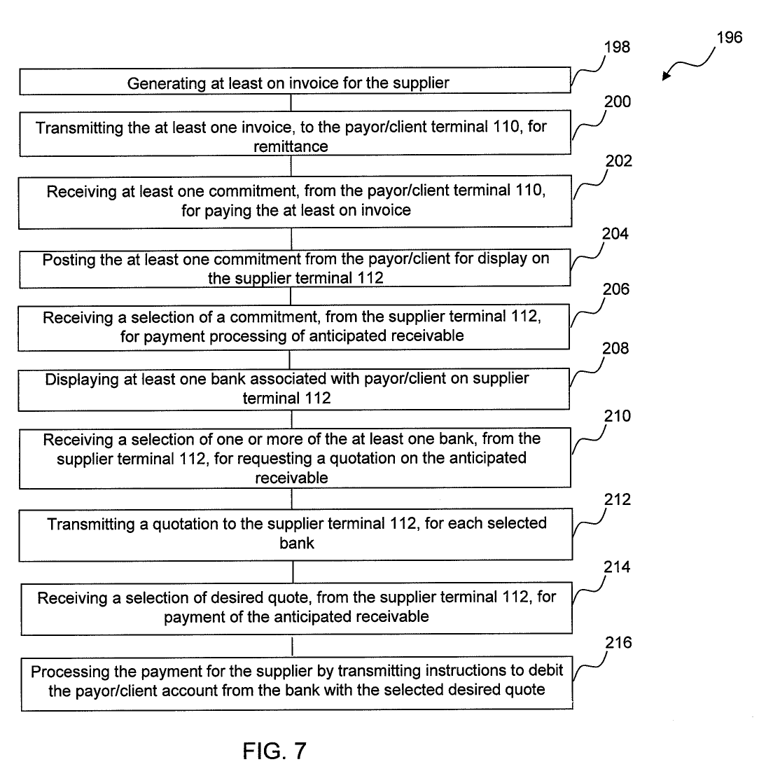

FIG. 7 illustrates an exemplary flowchart 196 outlining the operation of the visibility system 105 of FIG. 1 for electronically managing commitments and receivables between companies, according to an embodiment of the present disclosure. As can be appreciated, the server 120 of the visibility system 105 may be programmed with code instructions to facilitate electronic management of commitments and receivables between companies. The visibility system 105 may be programmed, for example, by transmitting code instructions to the server 120 from a local or remote storage device. The server 120 may be programmed with instructions to generate at least one invoice for the supplier on one or more orders (198). The supplier may use, for example, the supplier web portal to send instructions from the supplier terminal 112 for generation of the at least one invoice. The server 120 may transmit the at least one invoice, to the payor/client terminal 110, for remittance (200). The at least one invoice may be displayed on the payor/client terminal 110 via, for example, the client web portal. Upon reviewing the at least one invoice, the payor/client may choose to commit to payment of the at least one invoice. The server 120 may receive the at least one commitment, from the payor/client terminal 110, for paying the at least one invoice (202).

Next, the server 120 may be programmed with instructions to post the at least one commitment from the payor/client for display on the payee/supplier terminal 112 via, for example, the supplier web portal (204). Upon review of the posted commitments of invoices, the supplier may select ones that he/she wants to process for payment. The server 120 receives the selection of commitment, from the supplier terminal 112, for payment processing of anticipated receivable (206). In one embodiment, the server 120 may be programmed with instructions to display, at least one bank or financial institution name associated with the payor/client account, on the supplier terminal 112 for the supplier to request a quote on the anticipated receivable (208). As used herein, a “quote” and/or a “quotation” refers to a price proposed, presented and/or tendered for consideration through, for example, an offer, a bid or a proposal. The server 120 may then receive a selection of one or more of the at least one bank or financial institution, from the supplier terminal 112, for requesting a quotation on the anticipated receivable (210).

In one embodiment, the payor/client may register the at least one bank with the visibility system 105. As can be appreciated, the server 120 may be programmed with instructions to transmit the request for a quotation on the anticipated receivable to the selected banks terminal 114. Upon review of the client's commitments, the banks may choose to pay the full amount or a fraction thereof, for example, based on a discount rate. A quotation for payment of the anticipated receivable may then be transmitted to the supplier terminal 112 from each selected bank terminal 114 (212). As discussed below, the banks may also identify their discounted rate during registration, thereby allowing the server 120 to automatically compute the quotation based on the pre-identified discount rate. For example, a bank may choose to settle payment of the payor/client's commitment by paying the supplier 97% of the invoice, debiting the client 100% of the invoice, and monetizing 3% as a service charge for utilizing the visibility system 105. In another embodiment, the bank may also utilize a system that electronically processes the request of anticipated receivables. The visibility system 105 may remit the request from the supplier to the bank's system. The bank's system may then perform internal calculations and generate a quotation for the supplier.

Upon receiving a quote from one or more of the at least one bank, the supplier may select one for payment of the anticipated receivable. For example, if the supplier receives a quote from three banks, the supplier may select the one with the highest payment offer (i.e. less discount) or one based on past working relations, or any other reason for selecting a desirable quote. The server 120 may receive the selection of a financial institution with the desired quote, from the supplier terminal 112, for payment of the anticipated receivable (214). As can be appreciated, the server 120 may be programmed with instructions to process the payment request for the supplier by transmitting instructions to debit the payor/client account from the bank with the selected desired quote (216). If the payor/client has registered the bank with the visibility system 105, the instructions may be transmitted electronically to the bank terminal 114 for processing.

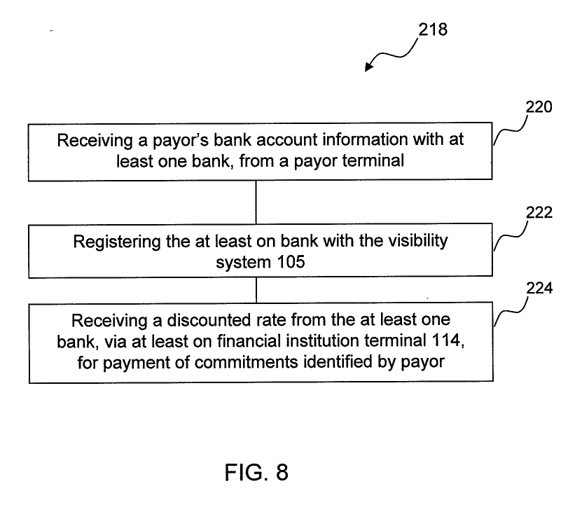

As can be appreciated, a payor may register one or more financial institutions with the visibility system 105 for remittance of invoices. FIG. 8 illustrates an exemplary flowchart 218 outlining the operation of the visibility system 105 of FIG. 1 for registering at least one financial institution to process client commitments and remit invoices, according to an embodiment of the present disclosure. As can be appreciated, the server 120 of the visibility system 105 may be programmed with code instructions to facilitate registration of financial institutions and processing of payments requests. The server 120 may be programmed with instructions to receive, from a payor terminal, a payor's bank account information with at least one bank (220). For example, a payor/client may transmit his/her bank account information with at least one bank via the client web portal displayed on client terminal 110. The bank account information may include, but not limited to, bank name, bank contact information, bank account number, and bank routing number. The payor/client may request the bank to process commitments, posted on the visibility system 105, for payment of a supplier's anticipated receivables.

Upon receiving the payor's bank account information, the server 120 may be programmed with instructions to register the at least one bank with the visibility system 105 (222). Registration information may be transmitted to the at least one financial institution terminal 114 to notify the at least one bank/financial institution of payor's accounts registered with the visibility system 105. In one embodiment, the at least one bank/financial institution may choose to apply a service fee for settling payment of invoices committed by the payor (224). The service fee may be a pre-identified discount rate percentage from the supplier's invoice. As discussed above, upon receiving a quotation from the payor's banks, the supplier may select the desired quote for payment of the anticipated receivable.

As noted above, the server 120 of the visibility system 105 may be programmed with code instructions to facilitate electronic management of commitments and receivables between companies. The server 120 may be programmed with instructions to generate financial documents (collection, payments) for the supplier from commitments (receipt, invoices and titles) posted by the client. It enables, among others, the assembly of commitments, the anticipation or installments of commitments and the generation of new billet with reduction on its value based on a previous billets and receivables. With the rendering of payment from the payor/client, the server 120 may be programmed with instructions to reconcile the commitments with the payments scheduled/made.

In one embodiment, a client receiving at least one invoice from the supplier, may carry out simulations, grouping, dividing into installments, anticipating or extending the payment of commitments (if permitted by supplier). As discussed above, the payor/client may then post the commitments and the server 120 may then process the selected commitments for payment of the supplier's anticipated receivables. The server 120 may generate respective financial documents related to the commitments selected. The server 120 may be programmed with instructions to reconcile the commitments with the payments made. For example, the server 120 may reconcile the commitments with the payments made using the generated financial documents. As can be appreciated, the reconciled commitments and payments made (and related documents) may be posted on the supplier web portal for display and for access on the supplier terminal 112.

As can be appreciated, the server 120 of the visibility system 105 may be programmed with code instructions to, among others, automate commercial and financial transactions, facilitate management of commitments (invoices) and receivables between companies, and notify beneficiaries of a scheduled payment. The server 120 may also be programmed with instructions to reconcile commitments with payments made.

According to one embodiment of the present disclosure, a system, method and machine-readable medium for submitting electronic loan applications to a lending institution with real-time commercial and financial data, is provided. Expressly, incorporated herein by reference, are U.S. Pat. Nos. 5,870,721, 5,995,947, 6,233,566, 6,385,594, and 6,611,816. The instant system, method and machine-readable medium of the present disclosure functions in conjunction with the same as detailed below.

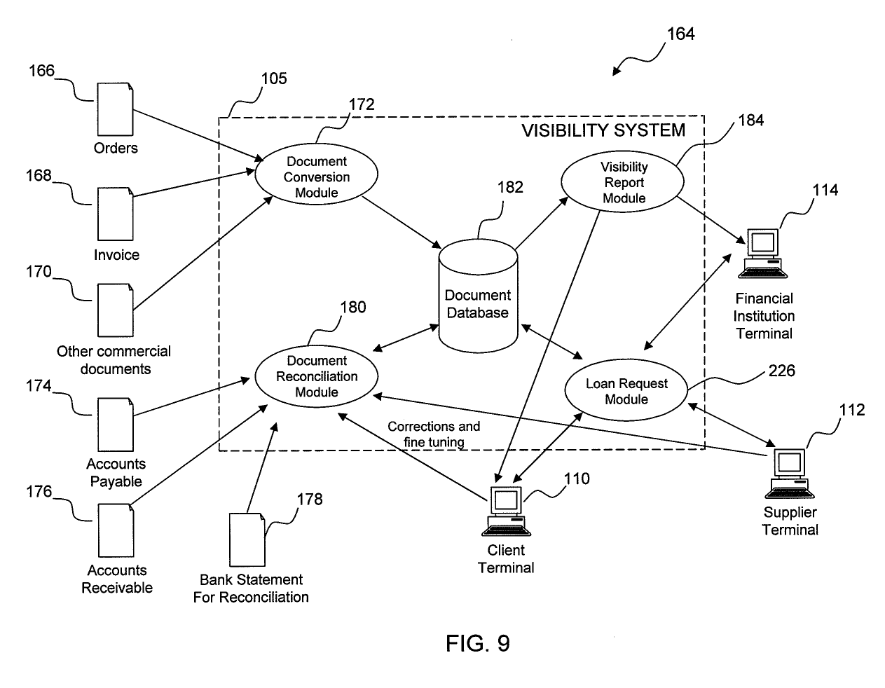

FIG. 9 is an exemplary flow diagram illustrating electronic submission of loan applications to a lending institution using the visibility system 105 of FIG. 1, according to an embodiment of the present disclosure. The visibility system 105 may include the database 182, the document conversion module 172, the document reconciliation module 180 and the visibility report module 182 of FIG. 5. Additionally, the visibility system 105 may include a loan request module 226.

The loan request module 226 may be used to facilitate electronic submission of loan applications to one or more financial institution terminals 114 (also referred to herein as lending institution terminals 114). A client or supplier (borrower) may electronically apply for a loan using the loan request module 226. In one embodiment, the loan request module 226 may retrieve the borrower's data, such as name, address, financial and commercial information, from the database 182. The loan request module 226 may prompt one or more fields, on the borrower's terminal 110 or 112, for entry of additional information to be submitted to the lending institution. For example, the loan request module 226 may prompt the borrower to enter the loan amount or credit line that the borrower seeks to obtain.

Financial and commercial data converted and reconciled by the document conversion module 172 and the document reconciliation module 180, respectively, and saved in database 182 (as shown in FIG. 5), may be provided, to the one or more lending institution terminals 114, with or within a predetermined period from electronically submitting the loan application. In one embodiment, real-time data of commercial and financial activity of the borrower may be provided with or within a predetermined period from electronically submitting the loan application. The electronic loan application submission may be transmitted using a Common Gateway Interface (CGI), Active File Transfer (ATF), a secured file on a secured webpage or web portal, or via email. In one embodiment, the electronic loan application submission is transmitted to one or more lending institutions subscribed to the visibility system 105 to allow the borrower to receive competing offers or bids from several lenders.

As noted above, the visibility system 105 may be adapted for real-time integration of the commercial data received from the plurality of business terminals. The visibility system 105 may be further adapted to extract financial data from the commercial data and determine if the borrower has a projected negative cash flow. The visibility system 105 may be adapted to generate a cash need report to identify that the borrower has a projected negative cash flow, and to transmit the report, with or within a predetermined period from electronically submitting the loan application, to the lending institution terminal(s) 114. The visibility system 105 may also be adapted to generate a cash flow report, and to transmit the cash flow report, with or within a predetermined period from electronically submitting the loan application, to the lending institution terminal(s) 114. As can be appreciated, these reports may be used, by the lending institution, to evaluate the financial condition of the borrower, within a certain period.

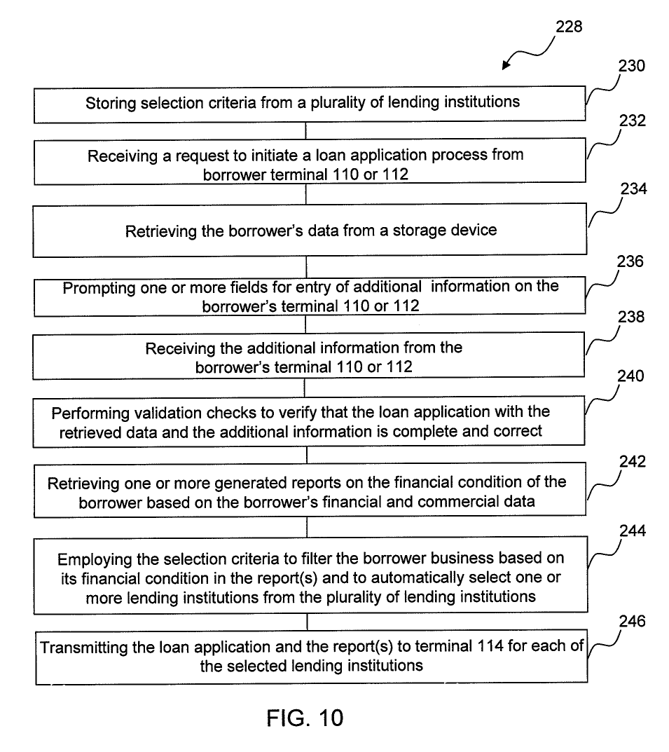

FIG. 10 illustrates an exemplary flowchart 228 outlining the operation of the visibility system 105 of FIG. 1 for submitting electronic loan applications to one or more lending institutions with real-time commercial and financial data, according to an embodiment of the present disclosure. As can be appreciated, the server 120 of the visibility system 105 may be programmed with code instructions to submit electronic loan applications, with one or more reports on a business' commercial and financial data, to one or more lending institutions. The reports, as discussed above, are generated to provide information on a business' financial condition and is based on the business' financial and commercial data. The visibility system 105 may be programmed, for example, by transmitting code instructions to the server 120 from a local or remote storage device. The server 120 may be programmed with instructions to store, in a storage device, a selection criteria from a plurality of lending institutions (230). The lending institutions may provide their selection criteria electronically from lending institution terminal 114 or by providing a hard copy which may be manually inputted into the system 105 and stored in a storage device. The selection criteria may be customizable by the specific lending institution in real time and unique to each lending institution. In one embodiment, the selection criteria may be customized to automatically concede loans or to direct the loan application with certain qualifications to a specific area/department at the lending institution.

As an illustration, the selection criteria for one lending institution may be to include a company when it will have a negative cash flow in the next 3 months, and/or it will have a accumulative positive cash flow to balance the negative in 6 months after the negative occurs. As an alternate example, the selection criteria of another lending institution may be to include a company when the average projected cash flow for the next 6 months is greater than a threshold cash flow and/or it will have a negative cash flow smaller then the threshold cash flow in the next month.

In one embodiment, the server 120 may be programmed with instructions to receive a request to initiate a loan application process from the borrower's terminal 110 or 112 (232). In response to the receipt of a request from the borrower's terminal 110 or 112 to initiate the loan application process, the server 120 may retrieve the borrower's data from the storage device (234). The borrower's data may include, but not limited to, the borrower's name, the borrower's address, the borrower's commercial data and the borrower's financial data. In one embodiment, the borrower's data may include the borrower's real-time commercial and financial data.

Additionally, in response to the receipt of a request from the borrower's terminal 110 or 112 to initiate the loan application process, the server 120 may prompt one or more fields for entry of additional information on the borrower's terminal 110 or 112 (236). The additional information may include, but not limited to, the loan amount or credit line that the borrower seeks to obtain. The server 120 may be programmed with instructions to receive the additional information from the borrower's terminal 110 or 112 (238) and perform validation checks to verify that the loan application with the retrieved data and the additional information is complete and correct (240). The server 120 may store the validated loan application in a storage device, such as database 182.

The server 120 may then retrieve, from database 182, one or more generated reports on the financial condition of the borrower based on the borrower's financial and commercial data (242). The server 120 may be programmed with instructions to employ the selection criteria to filter the borrower business based on its financial condition (presented in the report) and to automatically select one or more lending institutions from the plurality of lending institutions (244). The server 120 may filter the borrower business by determining if the borrower's financial condition, provided in the one or more generated reports, satisfies the selection criteria for each lending institution. Next, the server 120 may transmit the loan application and the one or more reports, to terminal 114 for each of the selected lending institution associated with the matching selection criteria (246). As can be appreciated, each selected lending institution may receive the loan application and a report with the borrower's real-time commercial and financial data.

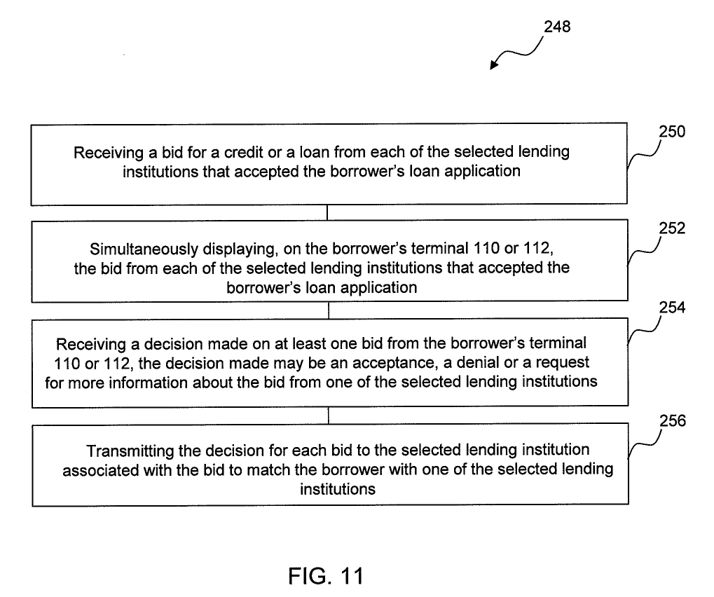

FIG. 11 illustrates an exemplary flowchart 248 outlining the operation of the visibility system 105 of FIG. 1 for matching a borrower to one or more lending institutions, according to an embodiment of the present disclosure. As can be appreciated, the server 120 of the visibility system 105 may be programmed with code instructions to match the borrower with one or more lending institutions. The visibility system 105 may be programmed, for example, by transmitting code instructions to the server 120 from a local or remote storage device. Upon receipt of the loan application from the server 120, the lending institution may review and determine to accept or deny the loan application. In one embodiment, the server 120 may be programmed with instructions to receive a bid of credit or a loan from each of the selected lending institution that accepted the borrower's loan application (250).

As noted above, the lending institution may customize the selection criteria to automatically concede loans, according to an embodiment of the present disclosure. In such instance, the server 120 may be programmed with instructions for employing the selection criteria to automatically accept or deny a borrower's loan or credit application. Additionally, the server 120 may be programmed with instructions for applying the selection criteria to automatically place a bid for a credit or a loan in connection with the accepted loan applications.

Next, the server 120 may simultaneously display, on the borrower's terminal 110 or 112, the bid from each of the selected lending institutions that accepted the borrower's loan application (252). The server 120 may then receive a decision on at least one bid from the borrower's terminal 110 or 112 (254). The decision may be an acceptance, a denial or a request for more information about the bid from one of the selected lending institutions. In one embodiment, the server 120 may be programmed with instructions to reject other bids displayed to the borrower with the acceptance of one bid by the borrower. The server 120 may transmit the decision for each bid to the selected lending institution associated with the bid to match the borrower with one of the selected lending institutions (256).

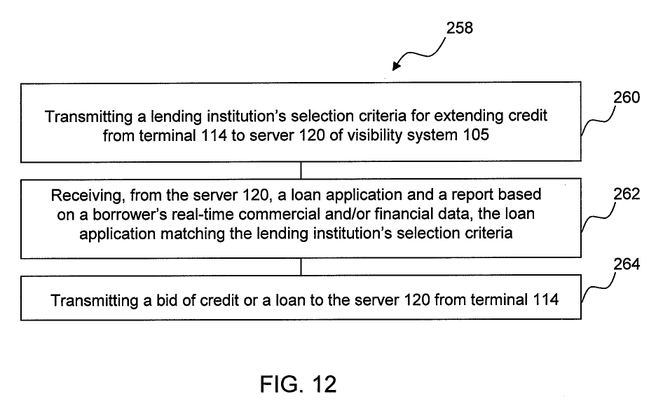

FIG. 12 illustrates an exemplary flowchart 258 outlining the operation of the lending institution terminal 114 of FIG. 1 for extending a credit or a loan, according to an embodiment of the present disclosure. As can be appreciated, the terminal 114 may include a processor programmed with code instructions to extend a credit or a loan to a borrower. The processor may be programmed, for example, by transmitting code instructions from a local or remote storage device. In one embodiment, the processor of terminal 114 may be programmed with code instructions to transmit, a lending institutions' selection criteria for extending a credit or a loan, to server 120 of the visibility system 105 (260). Alternatively, as noted above, the lending institution may provide may provide a hard copy of its selection criteria, which may then be manually inputted into the system 105 and stored in the storage device.

Next, the processor may be programmed with instructions to receive, from the server 120, a loan application and a report based on a borrower's data, which may include real-time commercial and/or financial data (262). As noted above, the loan application matches the lending institutions' selection criteria. Upon review of the loan application, the lending institution may choose to accept or deny a loan or credit to the borrower. For an accepted loan application, the lender may input bidding information, such as, but not limited to, the interest rate, the term, and/or the monthly payment. The processor of terminal 114 may be programmed with instructions to transmit the bid for a credit or a loan to the server 120 (264). As noted above, upon receiving the borrower's decision on one or more bids, the server 120 may transmit the borrower's decision to the lending institution to facilitate a match between the borrower and the lending institution.

According to one embodiment of the present disclosure, a system, method and machine-readable medium for consolidating financial information from multiple accounts maintained with a plurality of financial institutions, is provided. As can be appreciated, this consolidated financial information may be used for various applications of the visibility system 105 discussed above. For example, the consolidated financial information from the multiple accounts may be used to determine if at least one business has a projected negative cash flow. The consolidated financial information from multiple accounts/banks may also be transmitted with the loan application to a lending institution terminal. Furthermore, the system, method and machine-readable medium may be used to schedule a payment from one or more accounts/banks and transmit an electronic notification to a payee of the scheduled payment.

As discussed above, a customer (client or supplier) may register at least one bank or financial institution with the visibility system 105. Financial information, such as payments, collections, bank and credit card statements, for each of the at least one bank or financial institution, may be stored in the financial data database 134. This financial information may then be consolidated and displayed through a web page on customer terminals 110, 112 or 116.

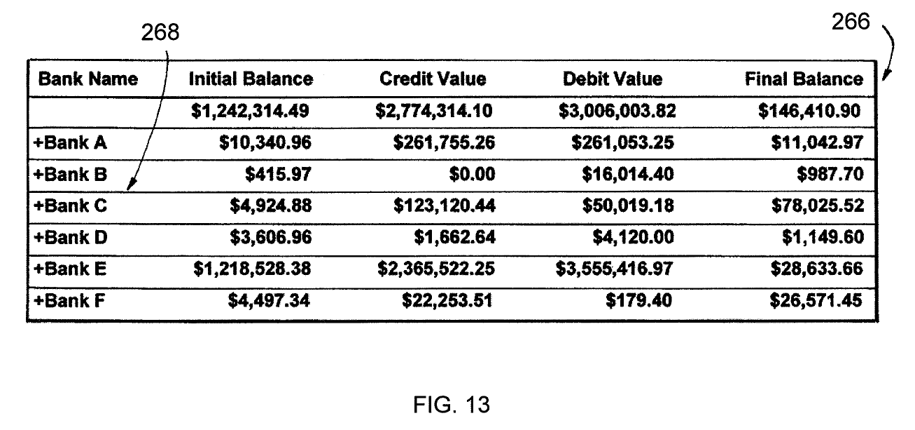

FIG. 13 is an exemplary table 266 illustrating consolidation of financial information from a plurality of financial institutions, according to an embodiment of the present disclosure. In this example, six banks 268 (Banks A, B, C, D, E and F) were registered for a customer (client or supplier) with the visibility system 105. The financial data, maintained at each bank, may be consolidated to display an initial balance, a credit (if any), a debit (if any) and a final balance. As shown in FIG. 13, the financial data, for each bank, may be displayed on one web page.

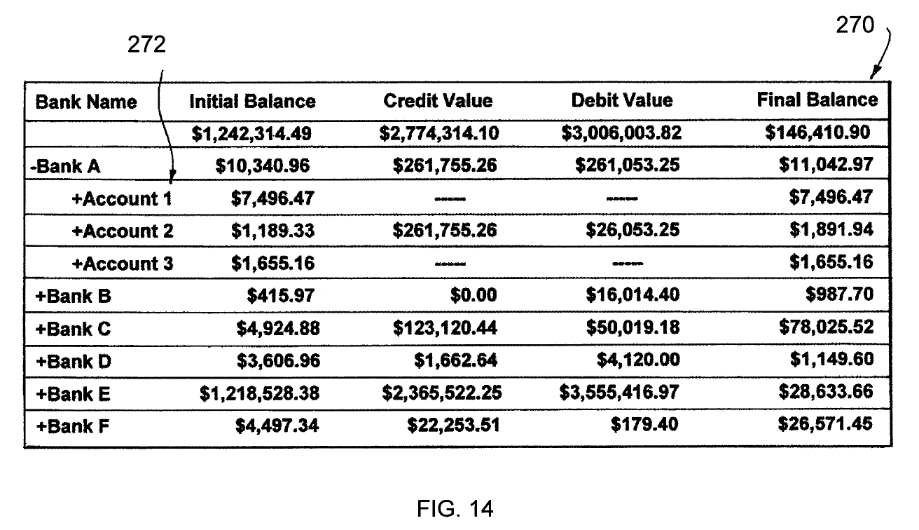

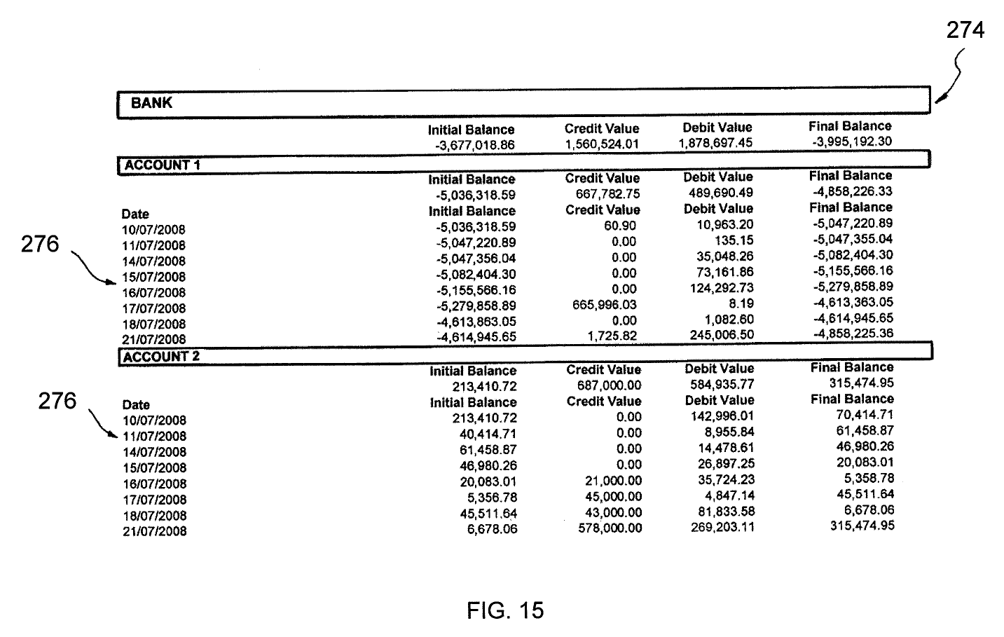

FIG. 14 is an exemplary table 270 illustrating consolidation of financial information for multiple accounts 272 maintained with Bank A of FIG. 13. As can be appreciated, the customer (client of supplier) may select at least one of the financial institutions, displayed on the web page, to view the accounts maintained with the selected financial institution. As shown in FIG. 14, the customer has three accounts 272 (Accounts 1, 2, and 3) maintained with Bank A. The financial data, for each account 272, may be consolidated to display an initial balance, a credit (if any), a debit (if any) and a final balance. Alternatively, financial transactions occurring within a predetermined period for each account may be displayed. FIG. 15 is an exemplary table 274 illustrating financial transactions 276 occurring within a predetermined period from multiple accounts maintained with Bank B of FIG. 13, according to an embodiment of the present disclosure.

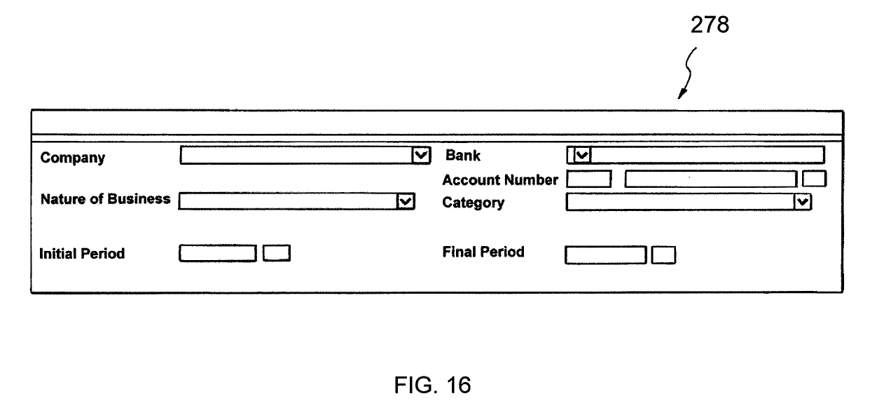

In one embodiment, the database management module 126 may include a consolidation module (not shown) to consolidate the financial data for each account maintained with each financial institution. The consolidation module may be operatively associated with a search engine (not shown) to filter, based on a certain threshold, through the financial data stored in the financial data database 134. As can be appreciated, FIGS. 13-15 may be displayed in response to a satisfaction of a filtering threshold to access certain financial data. FIG. 16 is an exemplary search engine interface 278 for filtering and/or consolidating the financial information, according to an embodiment of the present disclosure. Exemplary filtering and/or consolidation criteria may include bank name, account number, company name, date range, category, nature of business, etc.

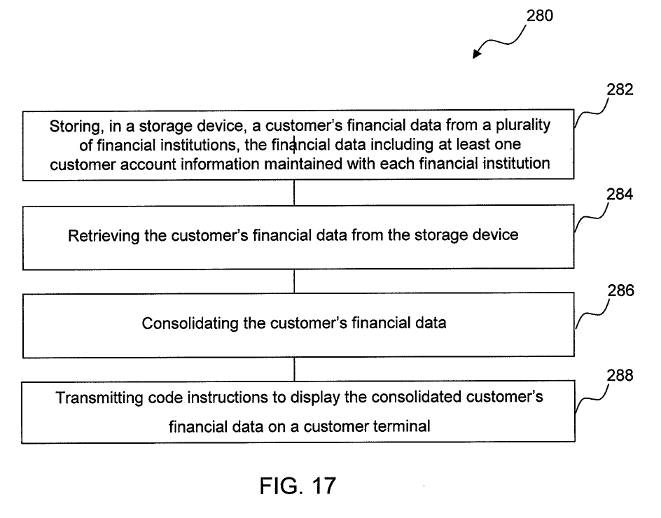

FIG. 17 illustrates an exemplary flowchart 280 outlining the operation of the visibility system 105 of FIG. 1 for consolidating financial information from multiple accounts maintained with a plurality of financial institutions, according to an embodiment of the present disclosure. As can be appreciated, the server 120 of the visibility system 105 may be programmed with code instructions to facilitate consolidation of multiple accounts maintained with a plurality of financial institutions. The server 120 may be programmed with code instructions to store, in a storage device, a customer's financial data from a plurality of financial institutions (282). The financial data may include at least one business account information maintained with each financial institution. The storage device, such as the financial data database 134, may be combined, further divided or cross-correlated with other storage devices within the server 120. The server 120 may then retrieve the customer's financial data from the storage device (284) and consolidate the customer's financial data (286). In one embodiment, shown in FIG. 13, the server 120 may consolidate financial transactions, with each financial institution, occurring within a predetermined period. Optionally, as shown in FIG. 14, the server 120 may consolidate financial transactions, with each customer account, occurring within a predetermined period. As can be appreciated, the server 120 may then transmit code instructions to simultaneously display the consolidated customer's financial data on terminal 110, 112, 114 or 116 (288).

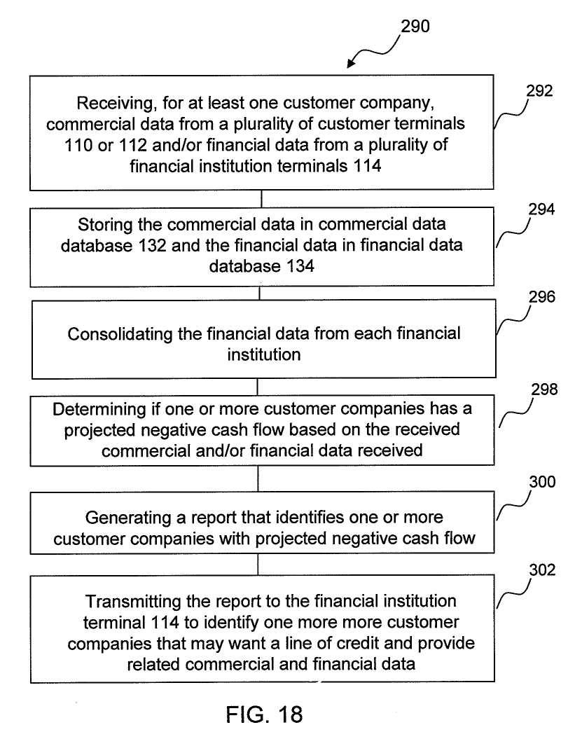

As discussed above, the consolidated financial information may be used for various applications of the visibility system 105. In one embodiment, the consolidated financial information may be used with a system, method and machine-readable medium for providing real-time data of commercial and financial activity of a business to a financial institution for visibility to guide credit operations and risk management. The system may include a storage device and a processor. The storage device may store commercial data and financial data for a plurality of businesses. The financial data may be obtained from a plurality of financial institutions and may include at least one business account information maintained with each financial institution. The processor may be programmed with code instructions to perform the following operations 290 illustrated in FIG. 18. The processor may be programmed with instructions to receive the commercial data from a plurality of business terminals and receive the financial data from a plurality of financial institution terminals (292). The processor may then store the commercial data in commercial data database 132 and the financial data in financial data database 134 (294). The processor may then consolidate the financial data from each financial institution (296). In one embodiment, the processor may then determine if one or more customer companies has a projected negative cash flow based on the received commercial and/or financial data received (298), generate a report to identify at least one business that has a projected negative cash flow (300), and transmit the report to at least one financial institution terminal to facilitate a financial institution's credit operations and risk management (302).

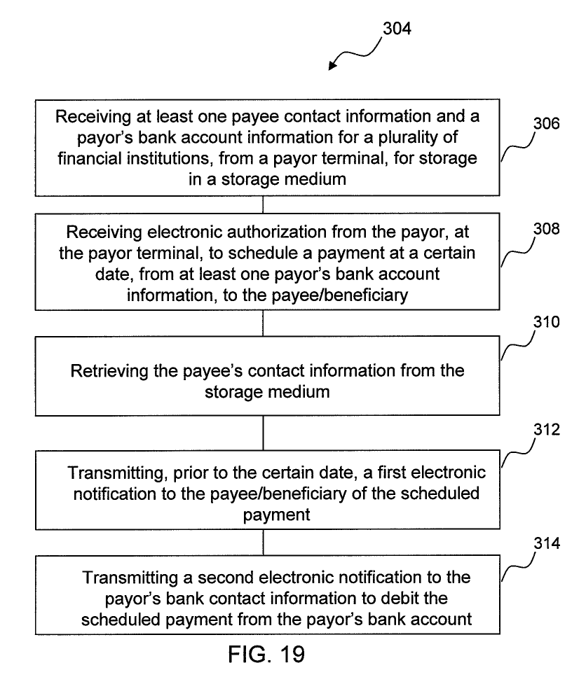

In one embodiment, the consolidated financial information may be used with a system, method and machine-readable medium for electronically notifying beneficiaries of a scheduled payment. The system may include a storage device and a processor. The storage device may store data including at least one payee contact information and a payor's bank account information for a plurality of financial institutions. The payor's bank account information may include a payor's bank name, a payor's bank contact information, a payor's bank account number, and a payor's bank routing number. The processor may be programmed with code instructions to perform the following operations 304 illustrated in FIG. 19. The processor may be programmed with instructions to receive the data from a payor terminal and transmit the data to the storage device for storage (306). The processor may then receive an electronic authorization from the payor terminal to schedule a payment to the payee, the payment to be made at a certain date using at least one payor's bank account information (308). The processor may retrieve the payee's contact information from the storage device to transmit a first electronic notification to the payee of the payment scheduled to be made at the certain date (310). The processor may then transmit, prior to the certain date, the first electronic notification to the payee of the payment scheduled to be made at the certain date (312). The processor may also transmit a second electronic notification to the payor's bank contact information to debit the scheduled payment from the payor's bank account for remittance of an invoice (314).

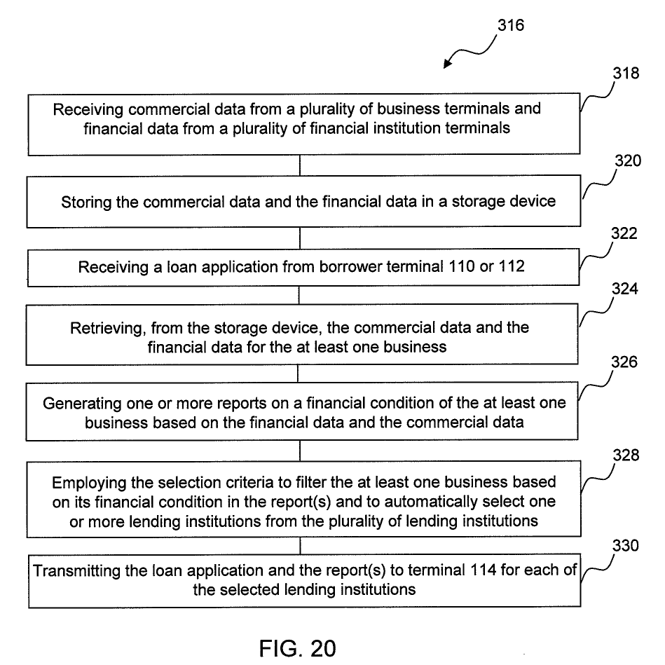

In one embodiment, the consolidated financial information may also be used with a system, method and machine-readable medium for processing loan applications. The system may include a storage device and a processor. The storage device may store commercial data and financial data for a plurality of businesses. The storage device may also store selection criteria data for a plurality of lending institutions. The financial data may be obtained from a plurality of financial institutions and may include at least one business account information maintained with each financial institution. The processor may be programmed with code instructions to perform the following operations 316 illustrated in FIG. 20. The processor may be programmed with instructions to receive the commercial data from a plurality of business terminals and receive the financial data from a plurality of financial institution terminals (318). The processor may then store the commercial data and the financial data in a storage device (320). As can be appreciated, the processor may be programmed with code instructions to receive a loan application from at least one business (322), and retrieve, from the storage device, the commercial data and the financial data for the at least one business (324). The processor may generate one or more reports on a financial condition of the at least one business based on the financial data and the commercial data (326). The processor may then apply the selection criteria data to filter the at least one business based on its financial condition in the report(s) and to automatically select one or more lending institutions from the plurality of lending institutions (328). The processor may then transmit the loan application and the report(s) to a lending institution terminal for each of the selected lending institutions (330).

In this description, various functions and operations may be described as being performed by or caused by software code to simplify description. However, those skilled in the art will recognize that what is meant by such expressions is that the functions result from execution of the code/instructions by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system. While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time. Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

The computer-readable media may store the instructions. In general, a tangible machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system. Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

The disclosure includes methods and apparatuses which perform these methods, including data processing systems which perform these methods, and computer readable media containing instructions which when executed on data processing systems cause the systems to perform these methods.

While the methods and systems have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

In this regard it should be understood that for practical reasons and so as to avoid adding potentially hundreds of claims, the applicant has presented claims with initial dependencies only.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A system for providing real-time data of commercial and financial activity of a business to a financial institution for visibility to guide credit operations and risk management, the system comprising:
a storage device to store commercial data from a plurality of businesses and financial data from a plurality of financial institutions, the financial data including at least one business account information maintained with each financial institution; and
a processor configured to:
receive the commercial data from a plurality of business terminals,
receive the financial data from a plurality of financial institution terminals,
store the commercial data and the financial data in the storage device, and
generate a report to identify at least one business that has a projected negative cash flow.

2. The system of claim 1, wherein the processor is further configured to transmit the report to at least one financial institution terminal to facilitate a financial institution's credit operations and risk management.

3. The system of claim 1, wherein the report is a cash need report accessible to a financial institution to identify at least one business to extend credit.

4. The system of claim 1, wherein the processor is further configured to generate a cash flow report to allow the financial institution to evaluate the financial condition of the at least one business within a certain period.

5. The system of claim 1, wherein the report is generated and transmitted periodically to at least one financial institution terminal.

6. The system of claim 1, wherein the commercial data is selected from a group consisting of purchase orders, receipts, invoices, titles, and contracts.

7. The system of claim 1, wherein the financial data is selected from a group consisting of payments, collections, bank statements and credit card statements.

8. A system for electronically notifying beneficiaries of a scheduled payment, the system comprising:
a storage device to store data including at least one payee contact information and a payor's bank account information with a plurality of financial institutions, the payor's bank account information is selected from a group consisting of a payor's bank name, a payor's bank contact information, a payor's bank account number, and a payor's bank routing number; and
a processor configured to:
receive the data from a payor terminal,
transmit the data to the storage device for storage,
receive an electronic authorization from the payor terminal to schedule a payment to the payee, the payment to be made at a certain date using at least one payor's bank account information,
retrieve the payee's contact information from the storage device to transmit a first electronic notification to the payee of the payment scheduled to be made at the certain date, and
transmit, prior to the certain date, the first electronic notification to the payee of the payment scheduled to be made at the certain date.

9. The system of claim 8, wherein the first electronic notification is selected from a group consisting of the time, date and amount of payment scheduled.

10. The system of claim 8, wherein the first electronic notification is in a form selected from a group consisting of an email alert and a web portal posting.

11. The system of claim 8, wherein the processor is further configured to transmit a second electronic notification to the payor's bank contact information to debit the scheduled payment from the payor's bank account for remittance of an invoice.

12. The system of claim 11, wherein the second electronic notification is in a form selected from a group consisting of an email alert and a web portal posting.

13. A system for processing loan applications, the system comprising:
a storage device to store financial data and selection criteria data from a plurality of financial institutions and commercial data from a plurality of businesses, the financial data including at least one business account information maintained with each financial institution, the commercial data including at least one of an invoice, a purchase order, a service order, a receipt, a title and a contract; and
a processor configured to:
receive a loan application from at least one business,
retrieve, from the storage device, the commercial data and the financial data for the at least one business,
generate a report on a financial condition of the at least one business based on the financial data and the commercial data,
apply the selection criteria data to filter the at least one business based on its financial condition and to automatically select one or more lending institutions from the plurality of lending institutions, and
transmit the report and the loan application to a lending institution terminal for each of the selected lending institutions.

14. The system of claim 13, wherein the processor is further configured to:
extract financial data from the commercial data,
wherein the report is further based on the extracted financial data.

15. The system of claim 13, wherein the storage device stores name and address data for the plurality of businesses, the processor being further configured to retrieve the name and address data from the storage device to include in the loan application.

16. The system of claim 13, wherein the processor is further configured to prompt, at a borrower terminal for each business, one or more fields to enter additional loan application information.

17. The system of claim 13, wherein the processor is further configured to obtain a bid for a credit or a loan for each of the selected lending institutions accepting the loan application.

18. The system of claim 17, wherein the bid is obtained using the selection criteria data to automatically concede a credit or a loan with certain bidding information selected from a group consisting of an interest rate and a monthly payment.

19. The system of claim 13, wherein the processor is further configured to:
obtain a bid for a credit or a loan from each of the selected lending institutions accepting the loan application;
simultaneously display, the bid from each of the selected lending institutions, on a borrower terminal;
receive a decision made on at least one bid from the borrower terminal, the decision made being selected from a group consisting of an acceptance, a denial or a request for more information about the bid from one of the selected lending institutions; and
transmitting the decision made for each bid to the selected lending institution associated with the bid to match the at least one business with one of the selected lending institutions.

20. The system of claim 13, wherein the commercial data and financial data are updated at a rate substantially the same as the commercial data is received from the plurality of business terminals and the financial data is received from plurality of financial institution terminals.
